(19) United States
(12) Patent Application Publication
(10) Pub. No.: US 2018/0324480 A1
(43) Pub. Date: Nov. 8, 2018

(54) Client and Method for Playing a Sequence of Video Streams, and Corresponding Server and Computer Program Product

(71) Applicant: Tradecast B.V., Zwolle (NL)

(72) Inventor: Yillmaz Matthieu Schoen, Doetinchem (NL)

(21) Appl. No.: 15/766,723

(22) PCT Filed: Oct. 8, 2015
(86) PCT No.: PCT/NL2015/050708

§ 371 Date: Apr. 6, 2018

(51) Int. Cl. H04N 21/262; H04N 21/2225; H04N 21/231

(52) U.S. Cl. CPC H04N 21/26258; H04N 21/23109; H04N 21/2225

(57) ABSTRACT

The invention relates to a client and method for playing a sequence of video streams, and corresponding server and computer program product. The client comprises: —a receiver arranged to receive from a server a data object defining a network address for each of a number of different video streams, a playing order and timing information; and —a processor arranged to, on the basis of the timing information and the playing order: o select the current video stream to be played; and o determine the current playback position within said current video stream, wherein the receiver is arranged to request video streams on the basis of the network addresses, and the processor is arranged to play video streams according to the playing order, starting from the selected current video stream at the determined current playback position, and to update the data object while playing video streams.

### FIELD OF THE INVENTION

The field of the invention relates to video streaming. In particular, the invention relates to a client for playing a sequence of video streams. The invention further relates to a system comprising a server and a number of such clients. The invention also relates to a server for generating a linear video stream from a number of different video streams. The invention also relates to a method for playing a sequence of video streams by a client, and a computer program product comprising non-transitory computer-executable instructions configured to execute said method.

### BACKGROUND

Video streaming is a technique which allows watching videos over the internet, in particular for video on demand. The popularity of over the top video delivery services, i.e. video distributed over the public internet, has dramatically increased in recent years. For example, applications such as YouTube, Vimeo and NetFlix offer an enormous amount of videos which can be watched by its users on demand.

One advantage of such internet video applications is lowering the costs for broadcasting programs and videos to a large audience. Whereas conventional television broadcasts can only be provided by specialized broadcasting companies, anyone can share videos online at virtually no costs.

Yet, internet video applications also suffer from drawbacks. One drawback is that users of online video applications need to search for videos to watch. Moreover, due to the large number of providers of online video services, users also have to navigate to the particular web site to get access to the desired content or install the particular app providing access to said content. Therefore, many user interactions are required before the user can start watching online video content.

### SUMMARY

An object of embodiments of the invention is to provide an improved client for watching video streams, preferably overcoming or at least reducing one or more of the above mentioned drawbacks.

According to an embodiment of the present invention, there is provided a client for playing a sequence of video streams. The client comprises a receiver component arranged to receive from a server a data object defining a network address for each of a number of different video streams. The data object further defines a playing order of said number of video streams, and server side timing information. The client further comprises a processor component connected to said receiver component. The processor component is arranged to select the current video stream to be played from said number of video streams on the basis of the server side timing information and the playing order defined in the data object. Moreover, the processor component is arranged to determine the current playback position within said current video stream on the basis of the server side timing information. The receiver component is arranged to request video streams on the basis of the network addresses defined in the data object. Moreover, the processor component is arranged to play video streams according to the playing order defined in the data object, starting from the selected current video stream at the determined current playback position. The processor component updates the data object while playing video streams upon receiving an updated data object by the receiver component.

In other words, the client receives a list of network address of different video streams. These video streams may originate from different sources. Moreover, the video streams may include video on demand (VoD) video streams, i.e. prerecorded video streams, and/or linear video streams, i.e. live video streams. The client is arranged to play these video stream one after the other, preferably as a continuous series, on the basis of the order defined in the data object.

Therefore, the user is provided continuously with video, without requiring the user to search for the desired content or to select the source of the desired content. Moreover, video streams in different file formats may be combined in the sequence.

A further advantage of embodiments of the invention is that it is the client which is requesting the video streams. The server only sends a network address for obtaining said video streams. Therefore, the server only requires a limited amount of resources. Therefore, the invention enables anyone to setup an online video channel wherein programs of different sources are combined, leveraging the existing infrastructure of online streaming services such as YouTube and Vimeo to deliver content to the end user.

The client may for example be implemented on a computer, such as a laptop or a desktop computer, a mobile device, such as a smart phone or a tablet computer or on a smart TV, i.e. a television having internet access.

The data object, e.g. a data package, may for example comprise a file or a JSON object. The network addresses included in the data object may for example be provided as URLs of the video streams.

The server side timing information has been included in the data object by the server, and is used to synchronize the playout of the video stream sequence across all clients requesting the corresponding data object. Preferably, the timing information may include the duration of the number of video streams and a time reference for synchronizing a client with the other clients. Each client can then determine on the basis of said timing information which video stream of the number of video streams indicated in the data objects it needs to start playing as the current video stream and at which playback position within said current video stream, in order to synchronize with other clients. Therefore, the user experience of conventional television is recreated, as the user can “tune-in” to the video content. Moreover, embodiments of the invention allow the creation of virtual “television channels”, by specifying the video streams and the playing order as stored in the data object.

The synchronization is further of relevance when placing a number of client devices in the same room, each client device showing the same video stream sequence, i.e. each client requesting the same data object. For example, a shop owner may want to display the same content on a number of television screens. In another example, a large number of screens may be employed at a public place, such as a train station or an airport. The synchronization provided by embodiment of the invention allows showing the same content at the same time.

Preferably, the processor component is arranged to loop said video streams defined in the data object. The data object basically provides an ordered list of video streams. After playing the last video stream in the ordered list, the processor component will continue by playing the first video stream in the ordered list, unless an update of the data object adds further video streams to the end of the ordered list.

Preferably, the data object is updated at least once during playing of each video stream. Additionally or alternatively, the client may request an update at periodic intervals, e.g. every 5-10 seconds.

To illustrate the above embodiment of the invention, a detailed example will be described next. In this example, the data object comprises the network addresses of three videos. The data object further defines the duration of these three videos. For example, the first video has a duration of 100 s, the second video has a duration of 300 s and the third video C has a duration of 500 s. The data object further defines a time reference of 6 Oct. 2015 at 21:45:33. Client A requests the data object and starts playing the video streams on 6 Oct. 2015: at 21:47:33, i.e. 120 seconds after the time reference included in the data object by the server. Therefore, client A can calculate that the current video is the second video and the playout has to start at 20 s in the second video. In another example, client B requests the data object and starts playing the video streams on 6 October on 21:49:33, i.e. 240 seconds after the time reference and 120 seconds after client A. Therefore, client B can calculate on the basis of the duration of the videos and the time reference that the second video is to be played, starting at a playback position of 140 s within the second video. Therefore, playback by client B is synchronized with client A, enabling client B to “tune in” at the same time as client A.

Continuing the above example, client A starts playing the second video by requesting the second video stream at the network address specified in the data object. During playing the second video stream client A requests the server for updates of the data object. The next video to be played is determined on the basis of the updated data object.

In an embodiment, the client further comprises a memory connected to said processor component. The processor component stores in the memory at least one video stream of the number of video streams defined in the data object. Further, the processor determines, before playing each video stream, whether said video stream is stored in the memory. If so, the processor plays the stored video stream. If the video stream is not stored in the memory, the processor streams the video stream from the network address defined in the data object.

Storing video streams has the advantage that bandwidth usage is reduced. For example, a shop owner using the client to display video in his shop may want to reduce bandwidth usage to avoid slowing down of other internet services. Moreover, the embodiment of the invention ensures a continuous playout of video, even when the bandwidth temporarily drops.

Especially when the video stream sequence is looped or one or more of the video streams is used multiple times in the sequence, the bandwidth is reduced by storing the video stream locally.

In a further embodiment, the data object further defines a file size for each video stream. The processor component selects the at least one video stream to be stored in the memory on the basis of the file size defined in the data object.

In a further embodiment, the processor component selects the at least one video stream to be stored by executing the following steps:
I. generating a list of the number of video streams defined in the data object;
II. determining the available storage capacity of the memory;
III. determine the video stream of the list having the largest file size;
IV. storing the video stream determined in step III if its file size is smaller than or equal to the available storage capacity determined in step II;
V. removing the video stream determined in step III from the list;
VI. repeating steps II-IV until the list is empty.

By storing the largest video streams, optimal use is made of the local storage. In particular when the video sequence is looped, bandwidth usage by the client is significantly reduced.

In a further embodiment, processor component determines for each video stream stored in the memory whether said video stream is included in the number of video streams defined in said initial or updated data object, upon receipt of the data object and/or after updating the data object. The processor component deletes a stored video stream from the memory if said stored video stream is not defined in the data object.

Therefore, the processor component ensures that memory/disk space is freed for storing video streams. This is in particular relevant when the client is embodied as a smart TV, which is typically provided with only a limited storage capacity. Moreover, when the client is embodied as an app on a mobile device, such as a smart phone, the operating system may limit the available storage capacity of said application. By making available storage capacity by deleting of selected video streams from local memory, efficient used is made of the available resources.

In an embodiment, the data object further defines a title for each video stream. The processor component determines the title of the video stream currently playing and/or the title of the next video stream to be played, on the basis of the title and/or playing order defined in the data object. The processor further renders an overlay over the currently playing video stream showing the title of the video stream currently playing and/or the title of the next video stream to be played.

In other words, the video stream is provided with an overlay by the client. Said overlay is generated on the basis of information on the title of the currently playing video stream and/or the next video stream. The client may format the titles according to a predefined format. In a first example, wherein the title of a first video is “cats in cardboard boxes” the overlay may indicate “NOW: Cats in Cardboard Boxes”. In another example, the title of the next video stream may be “dogs wearing funny hats”, and the overlay may indicate: “COMING UP: Dogs Wearing Funny Hats”. Preferably, the overlay is temporarily included in the video output, e.g. the overlay is displayed for 1-5 seconds. The overlay may be animated, for example by changing colour, transparency, brightness, position, size and/or rotation angle.

In a further embodiment, the processor renders the overlay over the currently playing video stream a predetermined time after playout of the current video stream has been started by the processor component.

In other words, while the playout of the sequence of video streams is synchronized by the client on the basis of the timing information, the timing of the overlay indicating the title of the current and/or next video may differ between clients. Therefore, the user knows which video is currently playing and/or will be played next when first “tuning in” to the video sequence. Even when the first video stream played by the client is started somewhere in the middle of its duration, the client will be notified of what he is currently watching and/or which video will be shown next.

In an embodiment, the data object further defines for at least one of the number of video streams a network address of overlay data. The processor component determines whether a network address of overlay data is included in the data object for the currently playing video stream. If said address is included, the processor component obtains, e.g. by requesting, said overlay data from the corresponding network address and renders an overlay over the currently playing video stream on the basis of the obtained overlay data. The overlay data is updated by the processor component upon receipt of updated overlay data by the receiver component from said network address. For example, the client may periodically request whether updates are available. The server providing the overlay data may respond by providing updated overlay data when an update is available or by sending a “no update available” message otherwise. The overlay data may for example comprise text data, image data, or even video data.

In an embodiment, the client is implemented as a web application executable by a web browser.

The web application may be implemented using HTML, CSS and JavaScript. For example, the overlays described above may be provided in the form of one or more HTML image elements, one or more HTML text elements and/or one or more HTML div elements. The overlays may be animated using CSS-animations and/or JavaScript for example.

An advantage of implementing the client as a web application is that various devices are capable of running the client, by running on said device a web browser for executing the client web application.

In an alternative embodiment, the client may be implemented as a device specific application. For example, the client may be implemented as a native app for an iOS or Android smart phone or tablet computer.

The invention further relates to a server for generating a linear video stream from a number of different video streams. In an embodiment, the server implements the client of the previous embodiment described above as a virtual device having a virtual display and a virtual audio output. The server captures the output of said virtual display and virtual audio output, and generates a linear video stream from said captured audio and video.

By running the client web application on a virtual device, and recording the output, the desktop or laptop implementation of the client can be utilized to create a linear stream for broadcasting. Therefore, a single video stream can be provided to clients. Moreover, the embodiment of the invention obviates the need for developing different native applications for each of a plurality of different devices, e.g. iOS devices and Android devices. In particular, for smart TV a variety of different operating systems are available. It is however noted that alternatively, the client may be implemented on these different system in the form of a native application, i.e. the client may be implemented as a device specific and/or an operating system specific application.

In an example, the browser environment on the server is equipped with an ad blocker, to remove advertisements from the video streams to be combined in the linear stream. This is of particular relevant when using free online video streams, e.g. from YouTube and Vimeo.

The invention further relates to a system comprising a server and a number of clients as described above. In an embodiment, the server is arranged to transmit the data object to a client upon request. The server defines the server side timing information of the data object such that playing of the sequence of video streams by the clients is synchronized.

The invention also relates to a method of playing a sequence of video streams by a client. In an embodiment, the method comprises the steps of:
a) receiving by the client from a server a data object defining the network address of each of a number of video streams, the playing order of said number of video streams and server side timing information;
b) requesting by the client of video streams on the basis of the network addresses of different video streams;
c) on the basis of the server side timing information and the playing order defined in the data object, selecting by the client the current video stream to be played from said number of video streams and determining the current playback position within said current video stream;
d) playing by the client said selected current video stream starting from the determined current playback position
e) playing by the client the next video stream according to the order defined in the data object,
   wherein step e) is repeated after playing of each video stream, wherein the client updates the data object while playing the video streams upon receiving an updated data object.

In an embodiment, the method further comprises storing on the client at least one video stream of the number of video streams defined in the data object. Playing of a video stream in steps d) and/or e) described comprises:
determining whether the video stream has been stored on the client; and
playing the stored video stream if the video stream has been stored on the client, and playing the video stream from a network location if the video stream has not been stored on the client.

In an embodiment, the data object received by the client further defines a file size for each video stream. The method further comprises selecting by the client the at least one video stream to be stored on the basis of the file size defined in the data object.

In a further embodiment, selecting the at least one video stream to be stored comprises:
I. generating a list of the number of video streams defined in the data object;
II. determining the available storage capacity of the client;
III. determine the video stream of the list having the largest file size;
IV. storing the videos stream determined in step III if its file size is smaller than or equal to the available storage capacity determined in step II;
V. removing the video stream determined in step III from the list;
VI. repeating steps II-IV until the list is empty.

In an embodiment, the method further comprises after receiving the data object and/or after updating the data object:
determining by the client for each video stream stored on the client whether said video stream is included in the number of video streams defined in the data object; and
deleting a stored video stream from the storage of the client if said stored video stream is not defined in the data object.

In an embodiment, the data object further defines a title of each video stream. The method further comprises:
determining by the client the title of the video stream currently played by the client and/or the title of the next video stream to be played, according to the title and/or playing order defined in the data object respectively; and
rendering by the client an overlay over the currently playing video stream showing the title of the video stream currently playing and/or the title of the next video stream to be played.

In a further embodiment, the overlay is rendered over the currently playing video stream starting from a predetermined time after the client has started playout of the currently playing video stream.

In an embodiment, the data object further defines for at least one of the number of video streams a location of a network address of overlay data. The method further comprises, if the client determines that a network address of overlay data has been included in the data object for the currently playing video stream:
obtaining by the client the overlay data for the currently playing video stream from said network address; and
rendering by the client an overlay over the currently playing video stream on the basis of the obtained overlay data,
   wherein the overlay data is updated upon receiving updated overlay data.

The invention also relates to a computer program product comprising non-transitory computer-executable instructions configured to, when executed, perform the steps of the method described above.

The same advantages and effects as describe above with reference to the client according to embodiments of the invention apply to the server, system, method and computer program product according to embodiment of the invention.

### BRIEF DESCRIPTION OF THE FIGURES

These and other aspects of the invention will be further elucidated with reference to the figures, in which:

FIG. 1 shows schematically a system comprising a server and a number of clients according to embodiments of the invention;

FIG. 2 shows schematically a client according to an embodiment of the invention;

FIG. 3 shows schematically communication between the client of FIG. 2, a server hosting the data object and a number of resources hosting different video streams;

FIG. 4 shows a flow diagram of freeing storage space on the client according to an embodiment of the method of the invention;

FIG. 5 shows a flow diagram of locally storing video streams on the client according to an embodiment of the method of the invention;

FIG. 6 shows a flow diagram of playing video streams using a mix of stored video streams and online video streams according to an embodiment of the method of the invention;

FIG. 7 shows a flow diagram of rendering by the client of an overlay which may be interactive and/or updated in real time according to an embodiment of the method of the invention;

FIG. 8 shows a flow diagram of rendering by the client of an overlay informing the user of the title of the current video stream and/or the title of the next video stream according to an embodiment of the method of the invention;

FIG. 9 shows schematically the timing of an EPG overlay at different clients; and

FIG. 10 shows schematically a server for generating a linear stream from a number of different video streams according to an embodiment of the invention.

### DETAILED DESCRIPTION OF ILLUSTRATED EMBODIMENTS

System 2 (FIG. 1) comprises a number of clients 4 connected to the internet 6, e.g. via a network interface. The clients 4 can communicate with a server 8 connected to the internet 6.

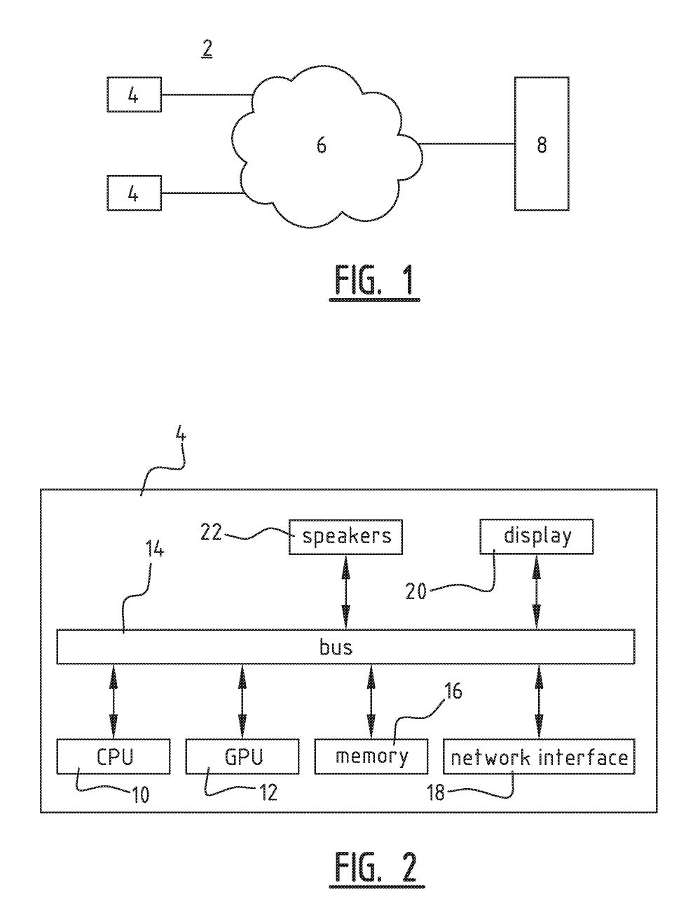

In an embodiment the client is provided as an electronic device 4 (FIG. 2) comprising a CPU 10, optionally a GPU, a bus 14 for connecting the components of the electronic device 4, a memory 16 a network interface 18, a display 20 and an audio output device, e.g. speakers 22.

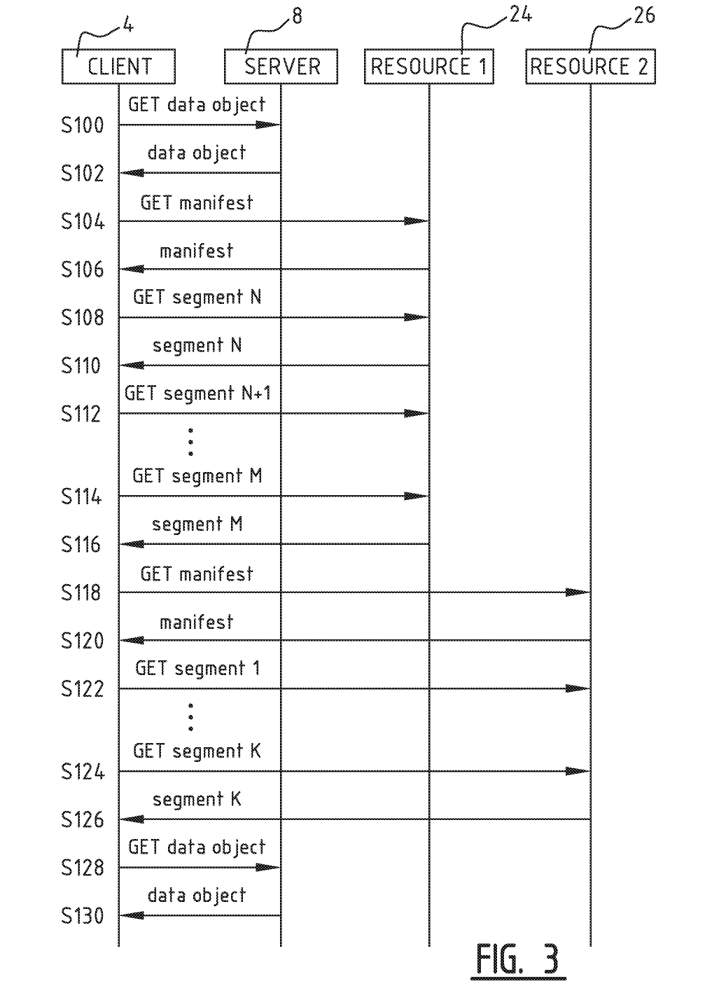

The client 4 requests a data object from server 8 in step S100 (FIG. 3). Upon receipt of said request, server 8 responds by transmitting the requested data object to the client 4 in step S102. The data object defines an URL of a number of different video streams. Said video streams may be hosted by other servers, e.g. resource servers 24, 26 as illustrated in FIG. 3, and may be provided in different file formats. The data object further defines a playing order of the video streams defined in the data object. Moreover, the data object includes timing information. For example, the data object may comprise structured data, e.g. according to a JSON or XML format.

An example of a data object in XML format is given below:

<data object>

<video>

<id> 1 </id>
<url>http://www.tradecast.eu/streams/example.mpd</url>
<title>Cats in cardboard boxes</title>
<duration>100</duration>

</video>
<video>

<id> 2 </id>
<url>http://www.anotherresource.com/stream.m3u8 </url>
<title>Dogs wearing funny hats</title>
<duration>300<duration>

</video>
<video>

<id> 3 </id>
<url>http://www.catvideos.com/explodingballoon.m3u8</url>
<title>Cat versus balloon</title>
<duration>500</duration>

</video>
<timing>

<start_date>6 October 2015</start_date>
<start_time>21:45:33</start_time>

</timing>

</data object>

This XML data object defines three video streams. For each video stream an ID, a URL, a title and a duration is defined. In the example, the URL of the first video (ID=1) refers to an MPEG-DASH file having extension ‘.mpd’, while the second video (ID=2) and the third video (ID=3) refer to a HTTP Live Stream (HLS) file having extension ‘.m3u8’.

The XML data further defines timing information, comprising a start date and a start time. In the current example, the IDs of the video items define the playing order. Alternatively, the playing order may be defined separately, e.g. by an array listing the IDs of the video in the desired order, i.e. in this example “1, 2, 3”.

In step S102 of the example, the client 4 receives the above data object of server 8 in response to the request in step S100. The client 4 then determines which of the videos defined in the data object to play. To this end, the client 4 starts by calculating the difference between the current time and the start time defined in the data object. For example, the current time may be 6 Oct. 2015: at 21:47:33, i.e. 120 seconds after the start time defined in the data object. Optionally, the modulus of the calculated difference and the total duration of all video items defined in the data object may be calculated to take into account looping of the video streams. Said total duration may be defined in the data object or may be calculated by the client on the basis of the durations defined in the data object.

The client 4 then starts a loop, wherein the durations of the video items as defined in the data object are added until the calculated difference of 120 s is exceeded. The client 4 then defines the last video added in the loop as the current video. Subsequently, the total duration of the video items preceding the current item is subtracted by the client 4 from the calculated difference to find the playback position within the current video. In pseudo code, this algorithm may for example appear as follows:

difference = current time − start time defined in data object
totalDuration = 0
n = number of video items in data object
idx = 1
for idx = 1 to n

previoustotalDuration = totalDuration
totalDuration = totalDuration + duration of video item (idx)
if totalDuration > difference

currentVideo = video item (idx)
playbackPosition = difference − previoustotalDuration
break from for-loop

end if

end for

In the present example, the client 4 calculates that the current video is video item having ID=2 and the playbackPosition is 20 s.

It is noted that in this example the server provides each client with the same server side timing information such that playout of the video streams is synchronized across different clients.

In another example, the server 8 may adjust the timing information in the data object each time a data object is requested. The server 8 keeps track of the playback position of the sequence of video streams, i.e. which video is playing at what playback position. Upon receiving a request for a data object of the client 4, the server sends a data object to the client 4 including server side timing information on the basis of said tracked playback position. In this example, different clients 4 may receive data objects comprising different timing information to ensure synchronization between clients.

For example, the server 8 may include in the data object a) the current video stream to be played and b) a time stamp of the current playback position within the current video stream. The client 4 can then play the current video stream from said current playback position received from the server 8. Preferably, the client 4 correct the current playback position received from the server for the time elapsed between sending the data object by the server 8 and receiving said object by the client and/or the start of playout by the client. The server 8 may include a timestamp in the data object indicating when the data object was sent to the client 4, in order for the client 4 to be able to calculate said correction.

For example, a client 4 requests a data object at 21:42:30. The server 8 responds by returning the data object at 21:42:31. The data object includes the following XML element:

<timing>

<transmit_time>21:42:31</transmit_time>
<item_current>2</item_current>
<offset>20</offset>

</timing>

The client 4 registers that said data object is received at 21:42:32. The client calculates the difference between transmit_time and time it received the data object, in this example 1 s. The client therefore starts the video stream having ID=2 from a playback position of offset+(received time−transmit_time), i.e. 20+1=21 s in this example.

Although the above examples use timing information having a precision of 1 second, it is also possible and even preferred according to the invention to synchronize with a finer precision, e.g. a millisecond precision. In other words, the timing information may be expressed with a precision of 1 millisecond or even less.

After determining the current video to be played, the client 4 obtains the video stream from the URL defined in the data object. In FIG. 3 this is illustrated in step S104 wherein client 4 requests a manifest file of the video stream from a second server 24 associated with the URL. The server 24 responds by sending the manifest file in step S106. The manifest file indicates the segments of the stream. On the basis of the playback position, determined as described above, and the manifest file, the client 4 requests the segments of the video stream in steps S108-S116. In particular, the segment of the video stream first requested by the client 4 in step S108 may not be the first segment of the video stream as indicated in the manifest file. In order to start from the calculated playback position, the client 4 request a corresponding segment N of the video stream. The server 24 responds by sending the requested segment, and the process continues for the subsequent segments in steps S110-S116, until the last segment M is reached.

After completing playout of a video stream, the client 4 request the next video stream according to the playing order defined in the data object. In the above example, the next video is the video having ID=3. In step S118 the client 4 requests the manifest file of the corresponding URL (http://www.catvideos.com/explodingballoon.m3u8). This URL may refer to another server 26, which responds to the request by sending the manifest file in step S120. The client 4 requests the segments defined in the manifest file, starting with the first segment in step S122 and ending with the last segment K in step S124.

After receiving the last segment K in step S126 the client 4 has reached the end of the playing order defined in the data object. The client 4 may request the data object S128 from server 8 to check whether the data object has been updated and more video items are available. The server 8 responds by sending the data object in step S130. If no further video items are defined in the data object, i.e. the last video has been played, the client 4 continues with the first video stream in the playing order as defined in the data object.

The client 4 may request the data object after each video stream to check for an update, e.g. also between steps S116 and S118. Moreover, the client 4 may request the data object while streaming a video, e.g. between steps S112 and S114 and/or between steps S122 and S124. Preferably, the client 4 requests the data object at least once during playout of each video, such that the client 4 always has up to date information on the next video stream to be played. Alternatively to requesting the data object to check for updates, the client 4 may send and update request to server 8. If an update is available, server 8 may send the updated data object to client 4. If no update is available, the server 8 may send a “no update” message to client 4 in response to the update request.

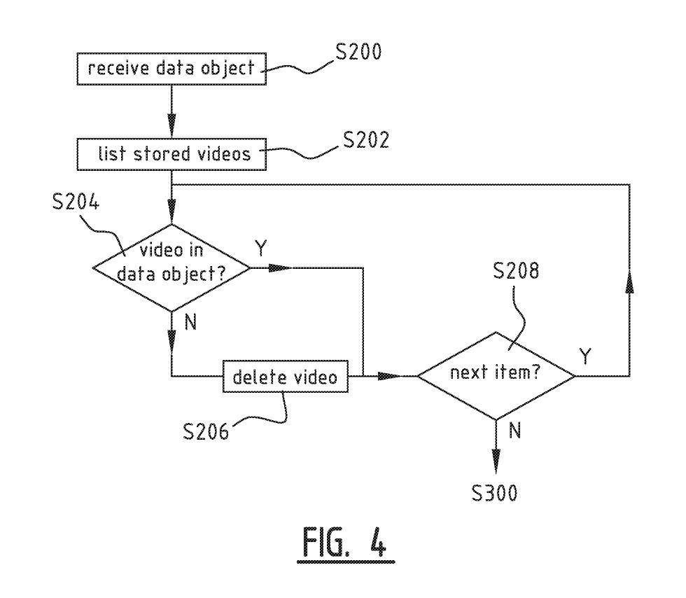

Client 4 may store some or all video streams on its memory 16, e.g. to reduce bandwidth usage. This is in particular relevant when looping the sequence of video streams, as a stored video stream will otherwise be requested multiple times. However, some device may be equipped with memory 16 having limited storage capacity. In particular, some smart TVs and mobile devices are equipped with only a modest amount of memory. Furthermore, video files in general require a relatively large amount of storage space, in particular high resolution video files. The client 4 therefore performs the method illustrated in FIG. 4 prior to starting the playout of the sequence of video streams to free storage space.

In a first step S200, the client 4 receives the data object. The client 4 then produces a list of the video streams stored in its memory 16 in step S202. A loop is then started over each video stream of the list. For each video stream on the list, i.e. each video stream stored in memory 16, the client 4 checks whether said video stream is included in the data object in step S204. If the stored video stream is not included in the data object, the client executes step S206 and deletes said stored video stream. Subsequently, client 4 checks whether there are further items on the list in step S208 and if so, returns to step S204 of the loop. If no further items appear on the list, i.e. all stored video streams have been processed, the loop ends.

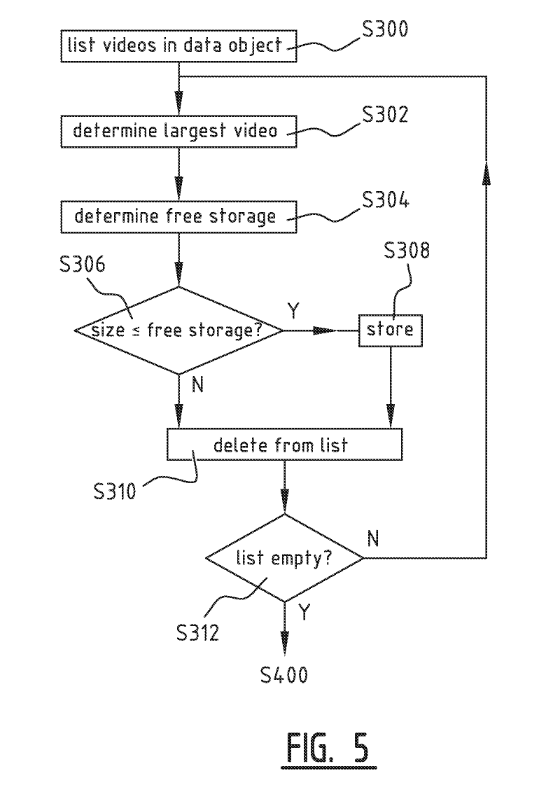

In case the client 4 is equipped with a memory 16 having a relatively small storage capacity, it is advantageous that the client 4 makes a selection of which video streams to store locally. In contrast, when ample storage capacity is available, the client 4 may be configured to store all video items locally. FIG. 5 illustrates a method for selecting which video stream to store locally. In step S300 the client 4 makes a list of the video streams defined in the data object. Subsequently, a loop is started over all video streams on said list. In a first step S302 of the loop, it is determined which video stream on the list has the largest file size. It is noted that the file size of each video stream may be defined in the data object. Alternatively, the client 4 may execute the steps of FIG. 5 using the duration of the video streams as defined in the data object as an indication of the file size, as in general longer video streams will take up more disk space.

The client 4 then proceeds to determining the free storage space available in its memory 16 in step S304. It is noted that the order of steps S302 and S304 may be reversed. Subsequently, the client 4 determines whether the size of the largest video stream is smaller or equal to the free storage space in step S306. If so, said largest video stream is flagged to be stored in step S308. If not, the largest video stream is not stored. The algorithm proceeds to step S310 wherein the largest video stream processed in steps S302-S308 is deleted from the list. If the list contains further video items, i.e. the list is not empty, the loop returns to step S302. If no further items remain on the list, i.e. the list is empty, the loop ends.

It is noted that in step S308 the video stream obtains a flag that it must be stored by the client 4. The client 4 may obtain the flagged video streams immediately from their network location. For example, the client 4 may download the video stream in step S308 or immediately after completing the loop, i.e. after step S312. Preferably however, the client 4 stores the video streams during playout, i.e. when streaming a video from a server 24, 26 the client 4 makes a local copy if the flag “store” has been set for said video stream.

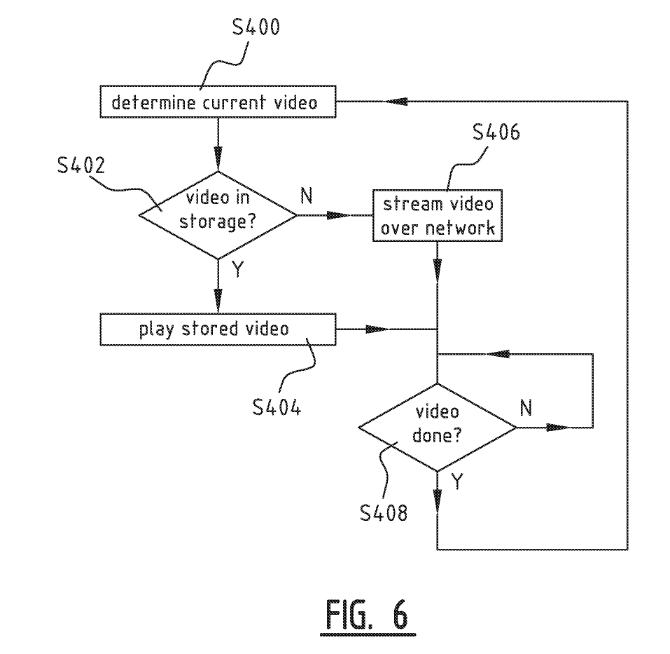

If a client 4 is configured to store some or all of the video streams locally, the steps of FIG. 6 may be executed before playing a video stream. In step S400 the client 4 determines the current video stream to be played, as described above in relation to FIG. 3. Subsequently, in step S402 the client 4 determines whether the current video stream is already stored in memory 16. If so, the stored video is played in step S404. If the video is not available from local memory 16, the client 4 obtains the video stream over the network in step S406, as previously described in relation to FIG. 3. The client 4 then waits until the current video has ended in step S408 to return to step S400 for repeating the process for the next video stream according to the playing order defined in the data object.

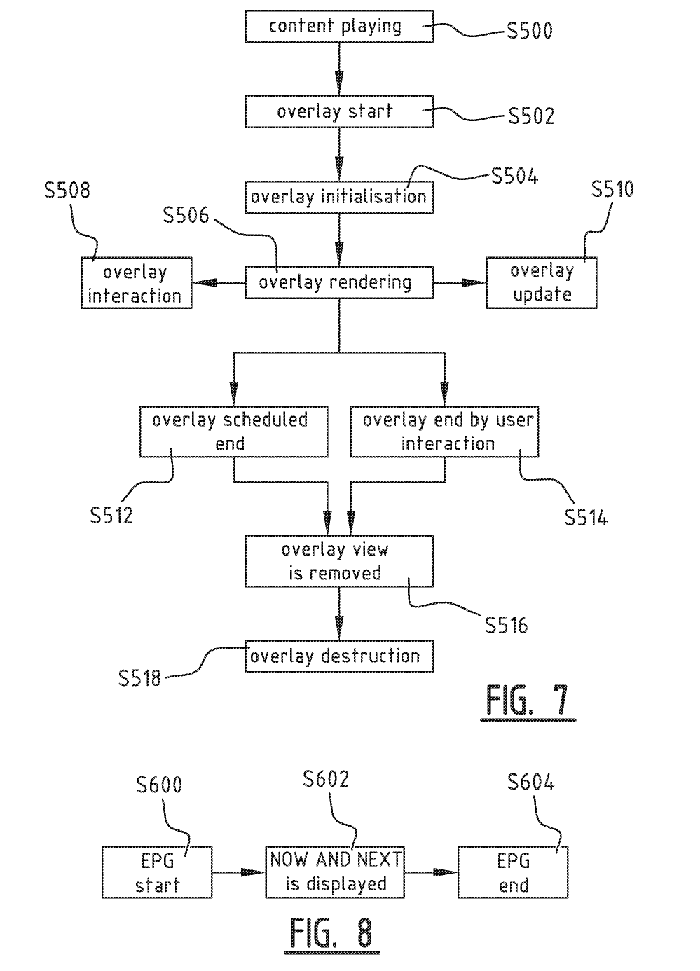

While playing the video streams, the client 4 may render an overlay over the video. This has been illustrated in FIG. 7. In step S500 content is playing, i.e. a video stream is played by client 4, as described above. In step S502 an overlay may be started by client 4. To this end, the client 4 may comprise a scheduler for managing the timing of the overlays. The timing information of overlays for a video stream may be defined in the data object. The overlay is initialized in step S504, wherein a view is created from a template in preparation of rendering. Subsequently, the overlay is rendered in step S506. Rendering may comprise rendering the overlay on a display device on top of the currently playing video stream.

The overlay may comprise interactive elements. For example, the overlay may show one or more interactive HTML elements, such as a hyperlink or button. In a further example, the overlay may load a web page, e.g. comprising images, text and interactive elements. To this end, the data object may include a URL of the web page of the overlay for the corresponding video stream. In an example, the overlay includes an interactive map, e.g. on the basis of Google Maps.

In another example, the overlay includes social media interactions. For example, the overlay may include the Facebook “like” button, to enable the user to like the currently playing video stream with his Facebook account. In another example, the overlay shows a Twitter feed.

In another example, the overlay includes text data and the client 4 formats said data according to a predefined format. For example, the text data may be obtained from an RSS feed and the client 4 may format the RSS data as a news ticker. For example, an RSS feed containing news items may be loaded and displayed as a news ticker in an overlay, e.g. at the top or bottom of the video.

In step S508 the client 4 may register user interactions with the overlay, e.g. activating a button or a hyperlink. In step S510 the overlay may be updated while playing the video stream. For example, an RSS feed may be updated frequently, e.g. every 10-60 seconds, to be able to present up to date items of said RSS feed. Therefore, the overlay information may be “live”, even when a video stream itself is pre-recorded.

The scheduler of the client 4 may end the overlay at a scheduled time. The scheduled time may be defined in the data object and corresponds to a playback position of the video where the overlay needs to be closed. In step S512 the scheduler checks whether the scheduled time has been reached. Alternatively or additionally, some overlays may be configured to allow a user to close the overlay, e.g. by clicking a button. In step S514, the client registers said user interaction for closing the overlay.

If the scheduler determines in step S512 that the scheduled end time has been reached and/or if a user interaction for closing the overlay has been registered in step S514, the client 4 removes the overlay from the video in step S516, and cleans up allocated resources of the overlay in step S518.

A particular advantageous type of overlay is an “EPG overlay”, i.e. an electronic program guide overlay. An embodiment of a method for rendering an EPG overlay is illustrated in FIG. 8. The client 4 may determine the title of the video stream currently playing and/or the title of the next video stream to be played in step S600. Said information is obtained from the data object received from server 8, which preferably includes a title for each video stream defined in said data object. On the basis of the title of the current and/or next video, an overlay is rendered in step S602. Said overlay may present the title in a predefined format and may animate said title(s). After a predetermined time, preferably defined in the data object, the EPG overlay is ended by client 4 by removing said overlay in step S604.

The data object may further define for each video stream whether or not to show an EPG overlay, e.g. by an “EPG overlay flag”, i.e. a Boolean indicating whether or not to show the EPG during playing said video stream. The client 4 then renders an EPG overlay only if the EPG overlay flag has been set to “true”.

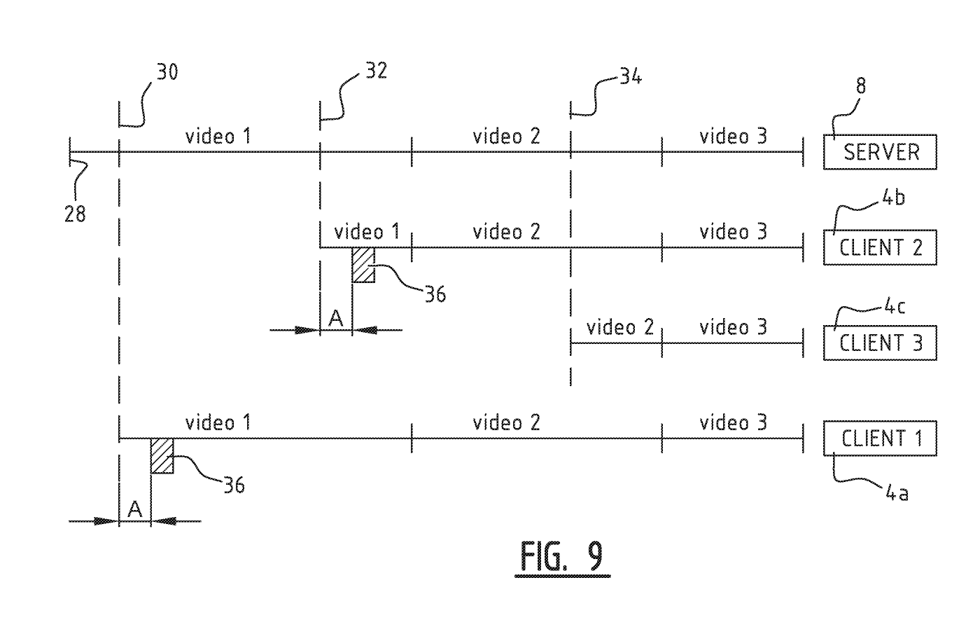

An example of the rendering of an EPG overlay by three different clients is illustrated in FIG. 9. The server 8 hosts a data object, defining a number of video stream items and a playing order. This has been reflected in FIG. 9 by representing the data object as a timeline, wherein the video stream items are shown according to the playing order. In the illustrated example, the data object defines three video stream items, video 1, video 2 and video 3, to be played in that order. The data object further defines a start time 28 of the sequence of video streams, to enable synchronization across multiple clients.

For example, a first client 4a receives the data object from server 8 and start playing the sequence of video streams at time instance 30, e.g. 20 s after start time 28. As describe above, client 4a will therefore start playing by playing video stream 1 at a playback position of 20 s within video stream 1. A second client 4b may also receive the data object from server 8 and start playing the sequence of video streams at time instance 32, e.g. 80 s after start time 28. As described above, the client 4b may determine the current video stream to be played and the playback position within said video stream on the basis of the duration of the video stream, which is defined in the data object. In the example shown, client 4b also starts by playing video stream 1. However, unlike client 4a, client 4b starts video stream 1 at a playback position of 80 s, to synchronize its playout with other clients.

The data object includes an “EPG overlay flag” for the first video stream item, indicating that an EPG overlay is to be rendered for video stream 1. The data object may optionally define a start time A of the EPG overlay. When the client 4a determines that the EPG overlay flag is set to “true”, it renders an overlay 36 over video stream 1, the EPG overlay 36 starting a time A after said client 4a has started playout of video stream 1. In the illustrated example, the EPG overlay 36 of video stream 1 shows the title of video stream 1, e.g. “NOW PLAYING: Cats in Cardboard Boxes” and/or the title of video stream 2, e.g. “COMING UP: Dogs Wearing Funny Hats”. In this example, the client 4a determines the starting time for overlay 36 on the basis of the time instance 30 at which it has started playout of the current video stream. Therefore, although playout of the video streams is synchronized across different clients 4a, 4b, 4c, the overlays may differ in timing. For example, client 4b renders overlay 36 after a time A has elapsed from time instance 32, whereas client 4a renders overlay 36 a time A after time instance 30.

It is noted that both clients 4a, 4b show any overlays of video stream 2 and/or video stream 3 simultaneously, since both will play these video streams from the start, instead of “tuning in” halfway.

In the illustrated example, a third client 4c start playing the sequence of video streams at time instance 34. Therefore, client 4c determines that the first video stream to be played is video stream 2. In the illustrated example, the data object defines the “EPG overlay flag” as “false” for video streams 2 and 3, such that client 4c does not show an overlay for said video streams.

The client 4 may be implemented as a web application, e.g. using HTML, CSS and JavaScript.

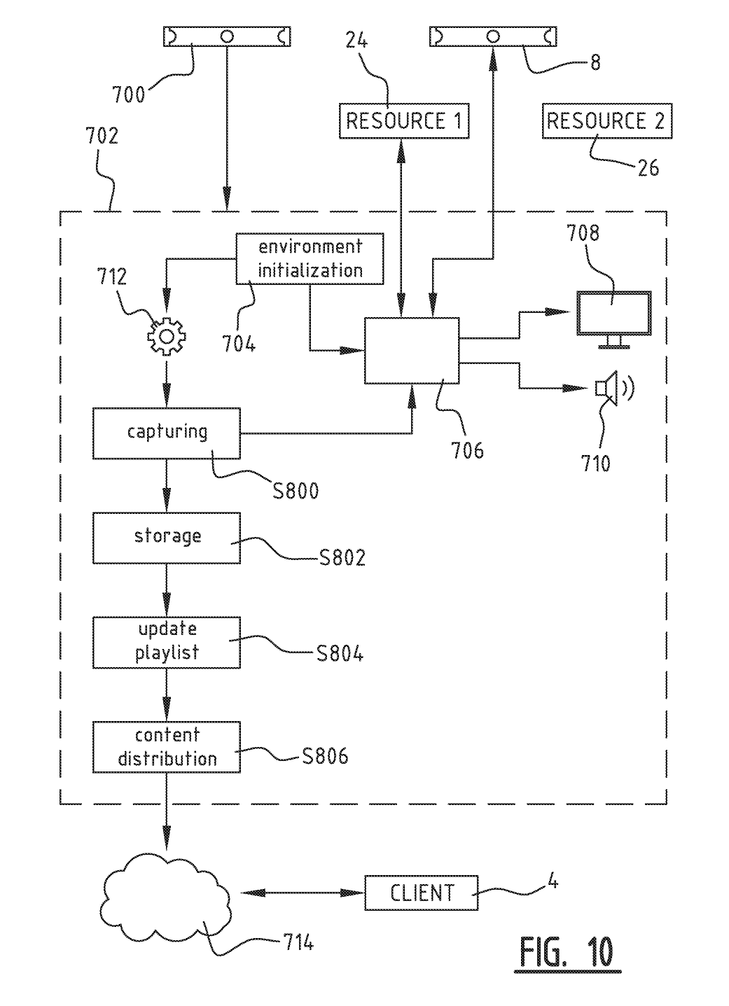

A render server 700 is shown in FIG. 10 for generating a linear stream using such a web application. The render server 700 comprises a render environment 702. The environment may be initialized by a render environment control module 704, wherein a browser instance 706 is launched for running the web application. In other words, browser 706 implements a client according to an embodiment of the invention on render server 700. As described above, such a client may access a sever 8 via a network to obtain the data object and subsequently access a number of different resource servers 24, 26 to obtain the corresponding video streams.

The browser instance 706 running within the render environment 702 is connected to a virtual display 708 and a virtual output 710. The render environment control module 704 initializes a process for capturing the output of virtual devices 708 and 710. For example, the FFmpeg framework may be used. It is noted that the captured video includes any overlays rendered by the web application running in browser 706. After capturing in step S800, the captured audio and video is divided into stream segments and stored in step S802. Preferably, the linear stream is stored as an adaptive stream, i.e. providing segments of different quality/bitrate. For example, the linear stream may be stored as an HLS stream. A manifest file (playlist) of the linear stream is created in step S804 and the manifest file and segments are uploaded to a content delivery network 714 in step S806. Therefore, render server 702 enables converting a sequence of video streams as produced by clients according to embodiment of the invention into a single linear video stream, such that clients 4 can access the linear video stream via content distribution network 714. The present invention is by no means limited to the above described preferred embodiments thereof. The rights sought are defined by the claims, within the scope of which many modifications can be envisaged.

1. Client for playing a sequence of video streams, comprising:
a receiver component arranged to receive from a server a data object defining a network address for each of a number of different video streams, a playing order of said number of video streams and server side timing information; and
a processor component connected to said receiver component, the processor component being arranged to, on the basis of the server side timing information and the playing order defined in the data object:
select the current video stream to be played from said number of video streams; and
determine the current playback position within said current video stream,
wherein the receiver component is further arranged to request video streams on the basis of the network addresses defined in the data object, and the processor component is further arranged to play video streams according to the playing order defined in the data object, starting from the selected current video stream at the determined current playback position, wherein the processor component is arranged to update the data object while playing video streams upon receiving an updated data object by the receiver component.

2. Client according to claim 1, further comprising a memory connected to said processor component, the processor component further being arranged to:
store in the memory at least one video stream of the number of video streams defined in the data object,
determine, before playing each video stream, whether said video stream to be played is stored in the memory, and
play the stored video stream if the processor component determines that the video stream to be played is stored in the memory, and else streaming the video stream from the network address defined in the data object.

3. Client according to claim 2, wherein the data object further defines a file size for each video stream, and the processor component is further arranged to select the at least one video stream to be stored in the memory on the basis of the file size defined in the data object.

4. Client according to claim 3, wherein the processor component is arranged to select the at least one video stream to be stored by executing the steps of:
I. generating a list of the number of video streams defined in the data object;
II. determining the available storage capacity of the memory;
III. determine the video stream of the list having the largest file size;
IV. storing the video stream determined in step III if its file size is smaller than or equal to the available storage capacity determined in step II;
V. removing the video stream determined in step III from the list; and
VI. repeating steps II-IV until the list is empty.

5. Client according to claim 2, wherein the processor component is further arranged to, upon receipt of the data object and/or after updating the data object:
determine for each video stream stored in the memory whether said video stream is included in the number of video stream defined in said initial or updated data object; and
deleting a stored video stream from the memory if said stored video stream is not defined in the data object.

6. Client according to claim 1, wherein the data object further defines a title for each video stream, the processor component further being arranged to:
determine the title of the video stream currently playing and/or the title of the next video stream to be played, on the basis of the title and/or playing order defined in the data object; and
render an overlay over the currently playing video stream showing the title of the video stream currently playing and/or the title of the next video stream to be played.

7. Client according to claim 6, wherein the processor component is arranged to render the overlay over the currently playing video stream a predetermined time after playout of the current video stream has been started by the processor component.

8. Client according to claim 1, wherein the data object further defines for at least one of the number of video streams a network address of overlay data, the processor component further being arranged to:
determine whether a network address of overlay data is included in the data object for the currently playing video stream; and
obtaining said overlay data from the corresponding network address and rendering an overlay over the currently playing video stream on the basis of the obtained overlay data, if said address is included in the data object,
wherein the processor component is arranged to update said overlay data upon receiving updated overlay data by the receiver component from said network address.

9. Client according to claim 1, the client being implemented as a web application executable by a web browser.

10. Server for generating a linear video stream from a number of different video streams, the server being arranged to implement the client according to claim 9 as a virtual device having a virtual display and a virtual audio output, the server being arranged to capture the output of said virtual display and virtual audio output, and generating a linear video stream from said captured audio and video.

11. System comprising a server and a number of clients according to claim 1, wherein the server is arranged to transmit the data object to a client upon request, wherein the server defines the server side timing information of the data object such that playing of the sequence of video streams by the clients is synchronized.

12. Method of playing a sequence of video streams by a client, comprising the steps of:
a) receiving by the client from a server a data object defining the network address of each of a number of video streams, the playing order of said number of video streams and server side timing information;
b) requesting by the client of video streams on the basis of the network addresses of different video streams;
c) on the basis of the server side timing information and the playing order defined in the data object, selecting by the client the current video stream to be played from said number of video streams and determining the current playback position within said current video stream;
d) playing by the client said selected current video stream starting from the determined current playback position; and
e) playing by the client the next video stream according to the order defined in the data object,
wherein step e) is repeated after playing of each video stream, wherein the client updates the data object while playing the video streams upon receiving an updated data object.

13. Method according to claim 12, further comprising:
storing on the client at least one video stream of the number of video streams defined in the data object,
wherein playing of a video stream in steps d) and/or e) comprises:
determining whether the video stream has been stored on the client; and
playing the stored video stream if the video stream has been stored on the client, and playing the video stream from a network location if the video stream has not been stored on the client.

14. Method according to claim 13, wherein the data object received by the client further defines a file size for each video stream, the method further comprising selecting by the client the at least one video stream to be stored on the basis of the file size defined in the data object.

15. Method according to claim 14, wherein selecting the at least one video stream to be stored comprises:
I. generating a list of the number of video streams defined in the data object;
II. determining the available storage capacity of the client;
III. determine the video stream of the list having the largest file size;
IV. storing the videos stream determined in step III if its file size is smaller than or equal to the available storage capacity determined in step II;
V. removing the video stream determined in step III from the list; and
VI. repeating steps II-IV until the list is empty.

16. Method according to claim 13, further comprising after receiving the data object and/or after updating the data object:
determining by the client for each video stream stored on the client whether said video stream is included in the number of video streams defined in the data object; and
deleting a stored video stream from the storage of the client if said stored video stream is not defined in the data object.

17. Method according to claim 12, wherein the data object further defines a title of each video stream, the method further comprising:
determining by the client the title of the video stream currently played by the client and/or the title of the next video stream to be played, according to the title and/or playing order defined in the data object respectively; and
rendering by the client an overlay over the currently playing video stream showing the title of the video stream currently playing and/or the title of the next video stream to be played.

18. Method according to claim 17, wherein the overlay is rendered over the currently playing video stream starting from a predetermined time after the client has started playout of the currently playing video stream.

19. Method according to claim 12, wherein the data object further defines for at least one of the number of video streams a location of a network address of overlay data, the method further comprising if the client determines that a network address of overlay data has been included in the data object for the currently playing video stream:
obtaining by the client the overlay data for the currently playing video stream from said network address; and
rendering by the client an overlay over the currently playing video stream on the basis of the obtained overlay data,
wherein the overlay data is updated upon receiving updated overlay data.

20. A computer program product comprising non-transitory computer-executable instructions configured to, when executed, perform the steps of the method according to claim 12.
